(19) United States
(12) Patent Application Publication
(10) Pub. No.: US 2025/0091455 A1
(43) Pub. Date: Mar. 20, 2025

(54) Double-Track Self-Grounding Wireless Charging Method and System for Charging Electric Vehicles While Driving

(71) Applicant: UNIST (ULSAN NATIONAL INSTITUTE OF SCIENCE AND TECHNOLOGY), Ulsan (KR)

(72) Inventors: Franklin BIEN, Ulsan (KR); Hyunkyeong JO, Ulsan (KR); Seoktae SEO, Ulsan (KR); Jungho KIM, Ulsan (KR)

(21) Appl. No.: 18/565,420

(22) PCT Filed: Nov. 28, 2023
(86) PCT No.: PCT/KR2023/019341

§ 371 Date: Apr. 3, 2024

(30) Foreign Application Priority Data
Feb. 23, 2023 (KR) 10-2023-0024572

(51) Int. Cl. B60L 53/12; B60L 53/30

(52) U.S. Cl. CPC B60L 53/12; B60L 53/32

(57) ABSTRACT

A double-track self-grounded wireless charging method and system for the charging of an electric vehicle during driving are presented. The double-track self-grounded wireless charging system includes a first transmission part and a second transmission part each including a plurality of wires that are uniformly connected to a road in parallel in order to generate a horizontal magnetic field for the charging of an electric vehicle during driving and not having a coil, wherein directions of currents that flow into the first transmission part and the second transmission part are opposite to each other, a reception part including a coil for vertically receiving the horizontal magnetic fields generated by the first transmission part and the second transmission part and mounted on the electric vehicle, and a double-track self-ground configured to prevent a closed loop from being formed between the first transmission part and the second transmission part.

### CROSS-REFERENCE TO RELATED APPLICATIONS AND PRIORITY

This patent application claims priority from PCT application no. PCT/KR2023/019341filed Nov. 28, 2024, which claims priority from Korean patent application no. 10-2023-0024572 filed Feb. 23, 2023.

### TECHNICAL FIELD

The present disclosure relates to relates to a double-track self-grounded wireless charging method and system for the charging of an electric vehicle during driving.

### BACKGROUND

An electric vehicle charging system may be basically defined as a system for charging a battery mounted on an electric vehicle by using power of the grid of a commercial power source or an energy storage device. The electric vehicle charging system may have various forms depending on the type of electric vehicle. For example, the electric vehicle charging system may include a conductive charging system using a cable or a contactless type wireless power transmission system.

In relation to the electric vehicle charging system, in the existing electric vehicle charging station, if multiple wireless charging pads are connected to one charger, there may be a problem in that multiple vehicles can be perform charging simultaneously due to the output restriction of the charger.

In general, the wireless charging system of an electric vehicle, which is installed at a parking lot of an apartment or a company, is limited installed only in a part of the entire parking zone by considering that an installation cost is great and a relatively small proportion of electric vehicles compared to common vehicles on which internal combustion engines are mounted. Meanwhile, in a conventional wireless charging system, when the charging of an electric vehicle is completed, the electric vehicle needs to be moved so that another electric vehicle can perform wireless charging because the number of charging zones in which a wireless charging pad has been installed is limited. Drivers who keep such a movement are not so many, and there is also a case in which a vehicle is parked in the charging zone for a long time. Furthermore, there is also a case in which a vehicle not an electric vehicle is parked at the charging zone. Accordingly, there is a problem in that a driver who frequently uses his or her electric vehicle or a driver wants to urgently charge his or her electric vehicle cannot wirelessly charge the electric vehicle due to the shortage of the charging zone when he or she tries to wirelessly charge the electric vehicle. Furthermore, there is a problem in that charging efficiency is reduced depending on a parking location of an electric vehicle because it is not easy for a driver to accurately park his or her electric vehicle at the location of a wireless charging pad upon wireless charging of the electric vehicle.

A limited battery capacity of the electric vehicle is a factor that restrains the sales of the electric vehicle. In order to solve such a problem, power is wirelessly supplied to an electric vehicle power that is being driven, but the existing coaxial coil wireless charging system is not suitable for such wireless power supply. A cost is increased because an active element is increased due to the addition of a switch, and stability in an exposed extreme environment may be reduced. If the location of a reception part that moves very fast is not accurately detected, there is a very great disadvantage in that power is never supplied.

### SUMMARY

An object of the present disclosure is to provide a double-track self-grounded wireless charging method and system, which have a high misalignment tolerance in a driving direction and a lateral direction and do not have a coil form in order to obtain high efficiency by reducing equivalent serial resistance (ESR) of a transmission part.

In an aspect, a double-track self-grounded wireless charging system for the charging of an electric vehicle during driving, which is proposed by the present disclosure, includes a transmission part including a plurality of wires that are uniformly connected to a road in parallel in order to generate a horizontal magnetic field for the charging of an electric vehicle during driving and not having a coil, and a reception part including a coil for vertically receiving the horizontal magnetic field generated by the transmission part and mounted on the electric vehicle.

The transmission part has the plurality of wires that are uniformly connected to the road in parallel disposed therein, generates the horizontal magnetic field having a uniform magnetic flux density in a direction in which a current flows by the plurality of wires, and increases a driving range thereof without alignment sensitivity.

The transmission part provides a misalignment tolerance in a lateral direction by generating the horizontal magnetic field having the uniform magnetic flux density in the direction in which the current flows by the plurality of wires.

The transmission part applies a cascade wire in order to reduce equivalent serial resistance (ESR).

In another aspect, a double-track self-grounded wireless charging system, which is proposed by the present disclosure, includes a first transmission part and a second transmission part each including a plurality of wires that are uniformly connected to a road in parallel in order to generate a horizontal magnetic field for the charging of an electric vehicle during driving and not having a coil, wherein directions of currents that flow into the first transmission part and the second transmission part are opposite to each other, a reception part including a coil for vertically receiving the horizontal magnetic fields generated by the first transmission part and the second transmission part and mounted on the electric vehicle, and a double-track self-ground configured to prevent a closed loop from being formed between the first transmission part and the second transmission part.

In the double-track self-ground, in order to reduce electromagnetic interference (EMI), a plurality of straight-line wires of the first transmission part is connected from a +pole of a power source to a plurality of straight-line wires of the second transmission part, and the plurality of straight-line wires of the second transmission part is connected to a −pole of the power source again so that the forming of the closed loop is prevented.

The reception part picks up a horizontal magnetic field that is generated from a return path that is formed due to the plurality of wires of the first transmission part and the second transmission part, which are uniformly connected in parallel.

Each of the first transmission part and the second transmission part has the plurality of wires that are uniformly connected to the road in parallel disposed therein, generates the horizontal magnetic field having a uniform magnetic flux density in a direction in which a current flows by the plurality of wires, increases a driving range thereof without alignment sensitivity. The directions of the horizontal magnetic fields generated by the first transmission part and the second transmission part, respectively, are opposite to each other.

Each of the first transmission part and the second transmission part provides a misalignment tolerance in a lateral direction by generating the horizontal magnetic field having the uniform magnetic flux density in the direction in which the current flows by the plurality of wires.

Each of the first transmission part and the second transmission part applies a cascade wire in order to reduce equivalent serial resistance (ESR).

It is possible to obtain high efficiency by increasing a misalignment tolerance in a driving direction and a lateral direction and reducing equivalent serial resistance (ESR) of the transmission part through the double-track self-grounded wireless charging method and system for the charging of an electric vehicle during driving according to embodiments of the present disclosure.

### BRIEF DESCRIPTION OF THE DRA WINGS

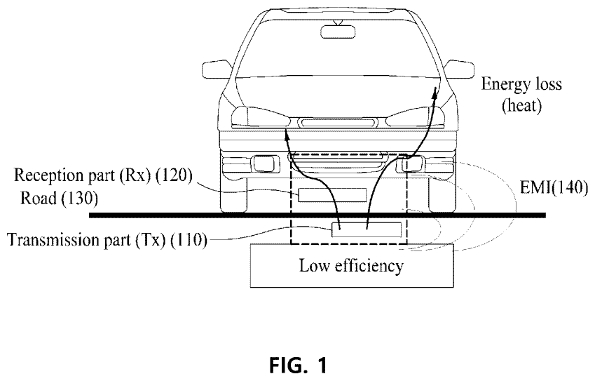

FIG. 1 is a concept view for describing a wireless charging system for the charging of an electric vehicle during driving according to a conventional technology.

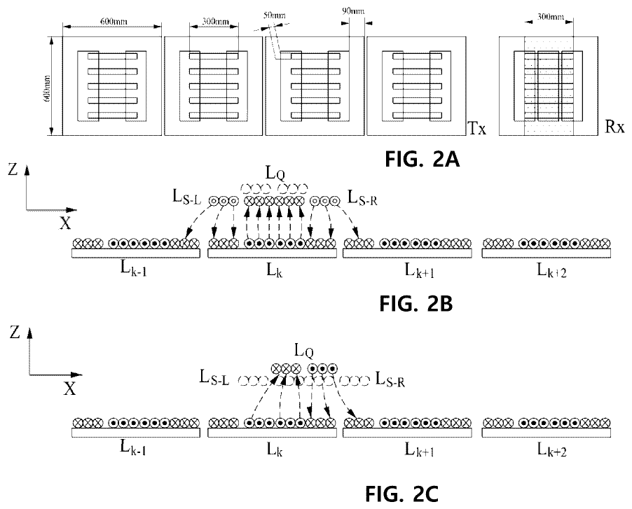

FIGS. 2A-2C are diagrams for describing WPT having multiple coils according to a conventional technology.

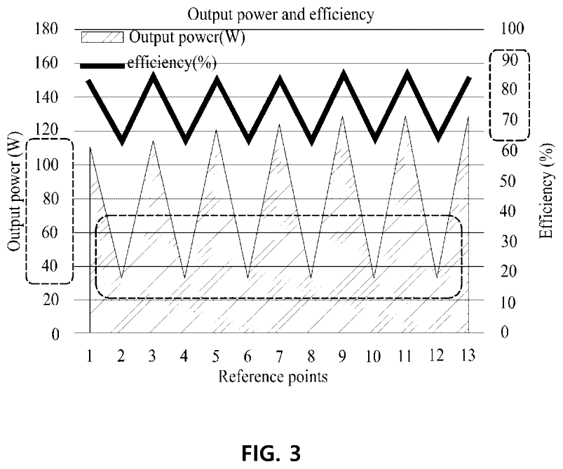

FIG. 3 is a graph illustrating output power of WPT having multiple coils according to a conventional technology.

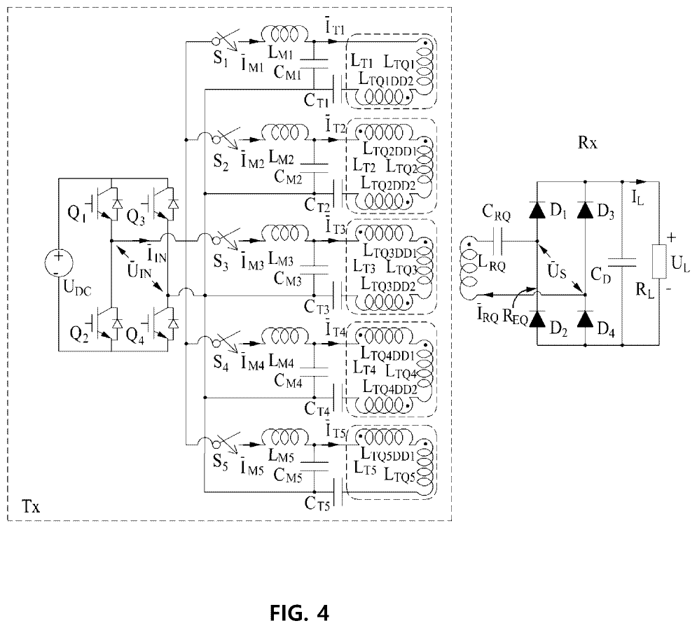

FIG. 4 is a diagram for describing WPT having separated coils according to a conventional technology.

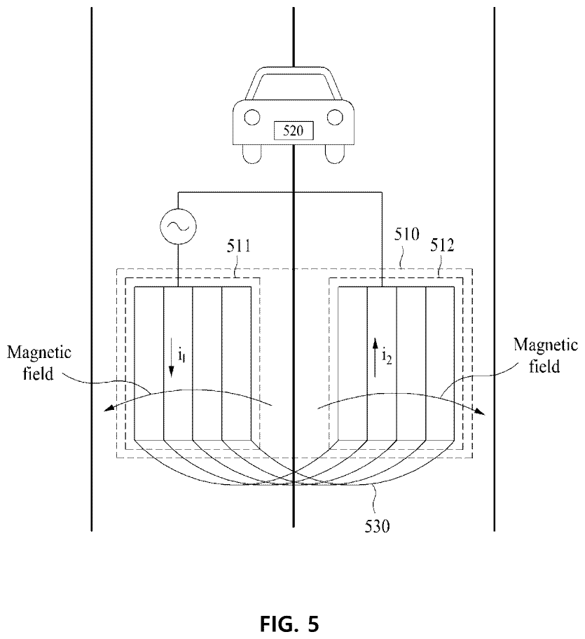

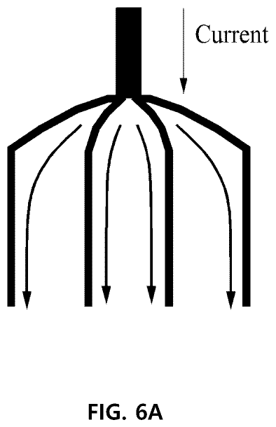

FIG. 5 is a diagram illustrating a construction of a double-track self-grounded wireless charging system for the charging of an electric vehicle during driving according to an embodiment of the present disclosure.

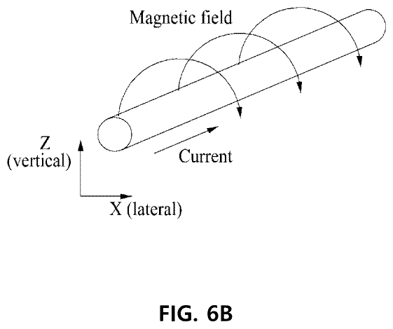

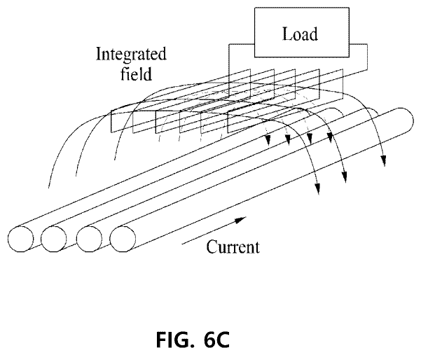

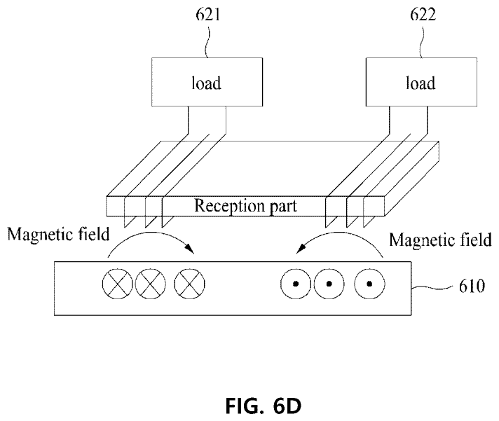

FIGS. 6A-6D are diagrams for describing WPT not having a coil according to an embodiment of the present disclosure.

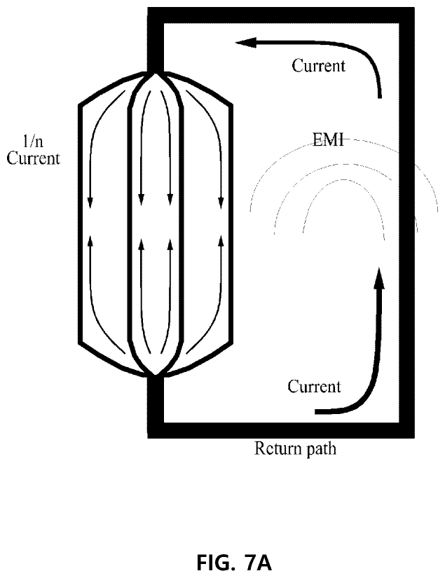

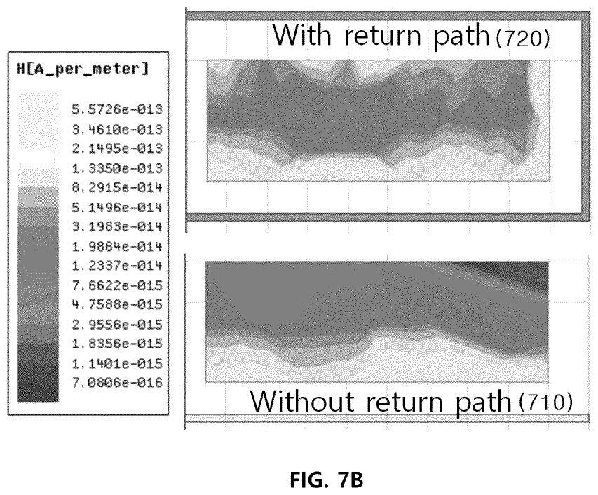

FIGS. 7A-7B are diagrams for describing a process of forming a magnetic field attributable to a return path according to an embodiment of the present disclosure.

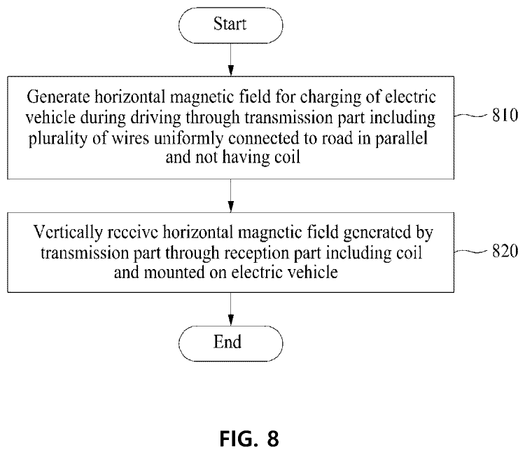

FIG. 8 is a flowchart for describing a double-track self-grounded wireless charging method for the charging of an electric vehicle during driving according to an embodiment of the present disclosure.

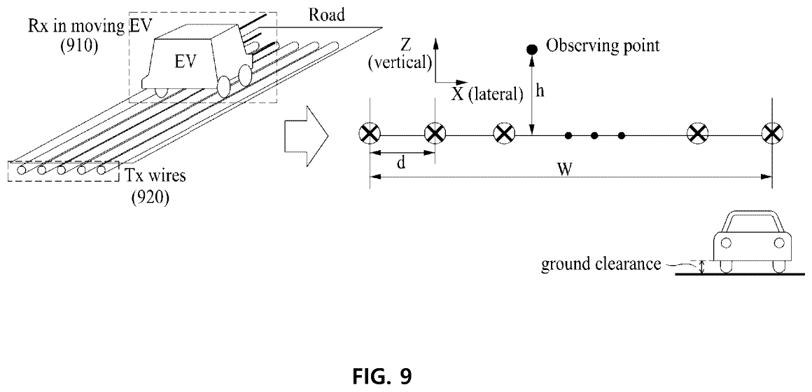

FIG. 9 is a diagram for describing a simulation process of a double-track self-grounded wireless charging model for the charging of an electric vehicle during driving according to an embodiment of the present disclosure.

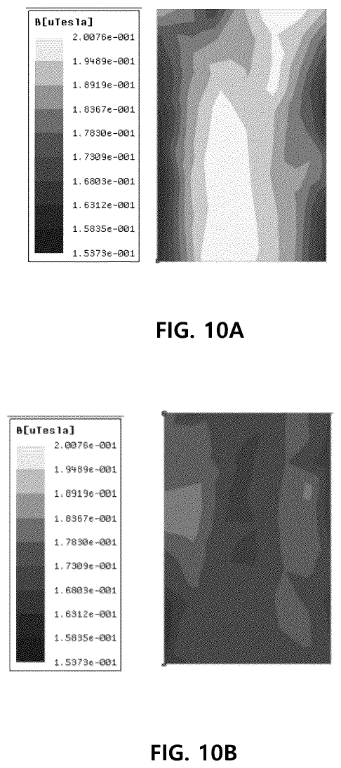

FIGS. 10A-10B are graphs illustrating the results of simulations of the double-track self-grounded wireless charging model for the charging of an electric vehicle during driving according to an embodiment of the present disclosure.

### DETAILED DESCRIPTION OF THE DRAWINGS

Hereinafter, embodiments of the present disclosure are described in detail with reference to the accompanying drawings.

FIG. 1 is a concept view for describing a wireless charging system for the charging of an electric vehicle during driving according to a conventional technology.

A misalignment tolerance has a problem in that the misalignment tolerance is continuous in a wireless power transmission system. In 3D coordinates, three degrees of location freedom are present in x, y, and z axes between a transmission part (Tx) 110 and a reception part (Rx) 120. Pickup power in the reception part (Rx) 120 may be influenced depending on a relative location according to the x, y, and z axes between the transmission part (Tx) 110 within a road and the reception part (Rx) 120 within an electric vehicle. This shows that a wireless power transfer (WPT) system is very sensitive to alignment between the transmission part and the reception part.

Misalignment between the transmission part and the reception part influences the entire system. First, a charging time is increased and the system becomes unstable as received power is changed.

Second, a lot of heat is generated because high power is necessary for the charging of the electric vehicle. The generated heat may degrade performance of a compensation part of the WPT system in addition to a part within the vehicle. Furthermore, electromagnetic interference (EMI) and the exposure of the human body may occur. Accordingly, a misalignment tolerance in WPT research is an important issue.

FIGS. 2A-2C are diagrams for describing WPT having multiple coils according to a conventional technology.

In a dynamic WPT system according to a conventional technology, a method of extending a charging distance without degrading performance is disclosed. That is, the system is a permission system for misalignment. In the example of FIGS. 2A-2C, in order to extend the charging distance, the coils of four same transmission parts (Tx) are disposed in series (FIG. 2A). However, when a reception part (Rx) moves on the four transmission parts (Tx) that are disposed in series (FIGS. 2B and 2B), severe coupling of power and efficiency occur due to coupling between the coils of adjacent transmission parts (Tx) depending on the transmission parts (Tx) that are aligned.

FIG. 3 is a graph illustrating output power of WPT having multiple coils according to a conventional technology.

In I the example of FIGS. 2A-2C, output power when the coils of the four same transmission parts (Tx) are disposed in series is greatly changed from 40 W to 100 W as in FIG. 3, and power efficiency thereof is changed from 70% to 90%. Such a change is caused because coupling occurs due to coupling between the coils of adjacent transmission parts (Tx) in the coils of the four transmission parts (Tx) that are connected in series. As a scheme for supplementing such a disadvantage, a WPT system having separated coils using switches was proposed as in FIG. 4.

FIG. 4 is a diagram for describing WPT having separated coils according to a conventional technology.

Referring to FIG. 4, a coupling problem attributable to coupling between the coils of adjacent transmission parts (Tx) can be improved because the coils of a plurality of transmission parts (Tx) are separated by using switches and only the transmission part (Tx) that is aligned with a reception part (Rx) is connected. When the switches are applied to a WPT system, a reception part (Rx) location detection system is required. Accordingly, a power loss attributable to an additional system may be expected. Furthermore, an added active element may cause a problem with the stability of the system in an extreme condition, such as a low temperature and wet environment, in addition to a cost. Furthermore, if a sensor does not detect an accurate location of the reception part (Rx), power is not delivered to a load.

Furthermore, regardless of whether a switch is present, a WPT system based on a unidirectional flux experiences a difficulty due to high equivalent serial resistance (ESR) because the coils of the transmission parts (Tx) has to be increased in series according to a required charging length. Furthermore, a problem may occur between system complexity and alignment sensitivity regardless of a switch is present in the system.

In a circuit model and efficiency formula illustrated in an equation below, ESR of a transmission part (Tx) that is represented as Rp is increased as the coil of the transmission part (Tx) is increased.

$$η = \frac{{R}_{L}}{( {R}_{S} + {R}_{L} ) ( 1 + \frac{{R}_{S} + {R}_{L}}{{( ω M )}^{2}} ) {R}_{P}}$$

In a dynamic WPT system not having a switch, in general, Rp is great in order to cover a long charging distance. In ESR and transfer efficiency of the transmission part (Tx), high ESR of the transmission part (Tx) degrades transfer efficiency despite great mutual inductance. That is, low ESR guarantees high efficiency through various types of mutual inductance. Accordingly, a system having both low ESR and a magnetic flux distribution suitable for dynamic charging of an electric vehicle is required.

The present disclosure is intended to propose a double-track self-grounded wireless charging system not having the existing coil form. In the proposed method, high efficiency can be obtained by increasing a misalignment tolerance in a driving direction and a lateral direction and reducing equivalent serial resistance (ESR) of a transmission part.

FIG. 5 is a diagram illustrating a construction of a double-track self-grounded wireless charging system for the charging of an electric vehicle during driving according to an embodiment of the present disclosure.

The double-track self-grounded wireless charging system for the charging of an electric vehicle during driving according to a first embodiment of the present disclosure may include a transmission part 510 and a reception part 520.

The transmission part 510 according to the first embodiment of the present disclosure has a plurality of wires that are uniformly connected to a road in parallel disposed therein in order to generate a horizontal magnetic field for the charging of an electric vehicle during driving, and does not have a form of a coil.

The transmission part 510 according to the first embodiment of the present disclosure has the plurality of wires that are uniformly connected to a road in parallel disposed therein, and may generate a horizontal magnetic field having a uniform magnetic flux density in the direction in which a current flows by the plurality of wires and may increase a driving range thereof without alignment sensitivity.

The transmission part 510 according to the first embodiment of the present disclosure can provide a misalignment tolerance in a lateral direction by generating a horizontal magnetic field having a uniform magnetic flux density in the direction in which a current flows by the plurality of wires.

The transmission part 510 according to the first embodiment of the present disclosure may apply a cascade wire in order to reduce equivalent serial resistance (ESR).

The reception part 520 according to the first embodiment of the present disclosure includes a coil for vertically receiving a horizontal magnetic field that is generated by the transmission part 510, and is mounted on an electric vehicle.

A double-track self-grounded wireless charging system for the charging of an electric vehicle during driving according to a second embodiment of the present disclosure may include the transmission part 510, the reception part 520, and a double-track self-ground 530.

The transmission part 510 according to the second embodiment of the present disclosure may include a first transmission part 511 and a second transmission part 512. The directions of currents i₁ and i₂ that flow into the first transmission part 511 and the second transmission part 512 are opposite to each other.

Each of the first transmission part 511 and the second transmission part 512 according to the second embodiment of the present disclosure includes a plurality of wires that are uniformly connected to a road in parallel in order to generate a horizontal magnetic field for the charging of an electric vehicle during driving, and does not have a form of a coil.

Each of the first transmission part 511 and the second transmission part 512 according to the second embodiment of the present disclosure has the plurality of wires that are uniformly connected to the road in parallel disposed therein, and may generate a horizontal magnetic field having a uniform magnetic flux density in the direction in which a current flows by the plurality of wires and may increase a driving range thereof without alignment sensitivity. The directions of the horizontal magnetic fields that are generated by the first transmission part 511 and the second transmission part 512, respectively, are opposite to each other.

Each of the first transmission part 511 and the second transmission part 512 according to the second embodiment of the present disclosure can provide a misalignment tolerance in a lateral direction by generating a horizontal magnetic field having a uniform magnetic flux density in the direction in which a current flows by the plurality of wires.

Each of the first transmission part 511 and the second transmission part 512 according to the second embodiment of the present disclosure may apply a cascade wire in order to reduce equivalent serial resistance (ESR).

The double-track self-ground 530 according to the second embodiment of the present disclosure prevents a closed loop from being formed between the first transmission part 511 and the second transmission part 512.

In the double-track self-ground 530 according to the second embodiment of the present disclosure, in order to reduce electromagnetic interference (EMI), a plurality of straight-line wires of the first transmission part is connected from a +pole of a power source to a plurality of straight-line wires of the second transmission part. The plurality of straight-line wires of the second transmission part is connected to a −pole of the power source again, so that the forming of the closed loop can be prevented.

The reception part 520 according to the second embodiment of the present disclosure includes the coil for vertically receiving a horizontal magnetic field that is generated by the transmission part 510, and is mounted on an electric vehicle.

The reception part 520 according to the second embodiment of the present disclosure can pick up a horizontal magnetic field that is generated from a return path that is formed due to the plurality of wires of the first transmission part 511 and the second transmission part 512, which are uniformly connected in parallel.

Power transfer efficiency may be represented as follows based on an equivalent exchange circuit model of a wireless power transfer system that resonates in an operating frequency (w) with mutual inductance (M) between the transmission part and the reception part according to an embodiment of the present disclosure.

$$η = \frac{{R}_{L}}{( {R}_{S} + {R}_{L} ) ( 1 + \frac{{R}_{P} ( {R}_{S} + {R}_{L} )}{{( ω M )}^{2}} )}$$

R_{L}, R_{P}, and R_{S} mean load resistance, transmission part resistance, and reception part resistance, respectively. In this case, when the system has adequate mutual inductance and load resistance, low transmission part resistance, that is, low ESR of the transmission part, guarantees high efficiency.

A transmission part having a double-track form in which several straight-line wires are connected has low ESR and also guarantees a uniform magnetic field in the direction in which a current proceeds. Accordingly, if a uniform magnetic field in the lateral direction can be formed, a double-track transmission part having a misalignment tolerance may be designed.

FIGS. 6A-6D are diagrams for describing WPT not having a coil according to an embodiment of the present disclosure.

FIG. 6A is a diagram illustrating a cascade wire in order to reduce equivalent serial resistance (ESR) according to an embodiment of the present disclosure. As illustrated in FIG. 6A, a plurality of wires of a transmission part not having a coil may be uniformly disposed in a road in a cascade way.

FIG. 6B illustrates a single straight-line wire not having a coil according to an embodiment of the present disclosure. FIG. 6C illustrates a plurality of omnidirectional straight-line wires not having a coil according to an embodiment of the present disclosure.

The transmission part not having a coil according to an embodiment of the present disclosure may have a uniform magnetic flux density in the direction in which a current flows by the plurality of wires that are uniformly (in other words, in parallel)-connected to a road in the cascade way. As described above, low ESR can be obtained by adopting the cascade wire as the transmission part.

In an embodiment of the present disclosure, ESR of the transmission part can be greatly reduced compared to the existing coil system and may become hundreds of nano Ohm per km because the Tx wires formed of copper having low resistance are connect in parallel. The driving range can be greatly extended without alignment sensitivity because a magnetic field that is generated by the long wire is uniform in the direction in which a current flows. The wires that have been properly disposed can generate a uniform magnetic flux density across the transmission part and can provide a misalignment tolerance in a lateral direction.

FIG. 6D is a diagram illustrating transmission and reception parts having a plurality of loads and coils according to an embodiment of the present disclosure.

FIG. 6D illustrates a transmission part 610 having a form in which a plurality of straight-line wires comes out from a +pole of a power source and is connected to a −pole of the power source again according to an embodiment of the present disclosure. In such a case, a magnetic field is formed in the same manner as that illustrated in FIG. 6D in the direction of a current that flows into the plurality of straight-line wires. In this case, a reception part has loads 621 and 622 having a structure, such as FIG. 6D, in order to pick up the magnetic field. In other words, the reception part may include two coils capable of including two loads.

FIGS. 7A-7B are diagrams for describing a process of forming a magnetic field attributable to a return path according to an embodiment of the present disclosure.

FIG. 7A illustrates the return path that is generated due to a plurality of wires that are uniformly connected in parallel in a transmission part according to an embodiment of the present disclosure.

Referring to FIG. 7B, it may be seen that electromagnetic interference (EMI) occurs in a case in which the return path is present (720) compared to a case in which the return path is not present (710).

In the present disclosure, in order to reduce electromagnetic interference (EMI) through the double-track self-grounded, a plurality of straight-line wires of a first transmission part may be connected from a +pole of a power source to a plurality of straight-line wires of a second transmission part, and the plurality of straight-line wires of the second transmission part may be connected to a −pole of the power source again, so that the forming of the closed loop can be prevented. Accordingly, a reception part according to an embodiment of the present disclosure can pick up a horizontal magnetic field that is generated in a return path that is formed by the plurality of wires that are uniformly connected in parallel.

FIG. 8 is a flowchart for describing a double-track self-grounded wireless charging method for the charging of an electric vehicle during driving according to an embodiment of the present disclosure.

The proposed double-track self-grounded wireless charging method for the charging of an electric vehicle during driving may include step 810 of generating a horizontal magnetic field for the charging of an electric vehicle during driving through a transmission part that includes a plurality of wires that are uniformly connected to a road in parallel and that does not have a coil and step 820 of vertically receiving the horizontal magnetic field that is generated by the transmission part through a reception part that includes a coil and that is mounted on the electric vehicle.

In step 810, the horizontal magnetic field for the charging of the electric vehicle during driving is generated through the transmission part that includes the plurality of wires that are uniformly connected to the road in parallel and that do not have a coil. The transmission part may include a first transmission part and a second transmission part. The directions of currents that flow into the first transmission part and the second transmission part are opposite to each other.

According to an embodiment of the present disclosure, the plurality of wires that are uniformly connected to the road in parallel may be disposed, may generate the horizontal magnetic field having a uniform magnetic flux density in the direction in which a current flows by the plurality of wires, and can increase a driving range thereof without alignment sensitivity. In this case, the directions of the horizontal magnetic fields that are generated by the first transmission part and the second transmission part, respectively, are opposite to each other.

According to an embodiment of the present disclosure, a misalignment tolerance in the lateral direction can be provided by generating the horizontal magnetic field having a uniform magnetic flux density in the direction in which a current flows by the plurality of wires.

In step 820, the horizontal magnetic field that is generated by the transmission part is vertically received through the reception part that includes a coil and that is mounted on the electric vehicle.

According to an embodiment of the present disclosure, in order to reduce electromagnetic interference (EMI), the plurality of straight-line wires of the first transmission part is connected from the +pole of the power source to the plurality of straight-line wires of the second transmission part, and the plurality of straight-line wires of the second transmission part is connected to the −pole of the power source again, so that the forming of a closed loop between the first transmission part and the second transmission part can be prevented through the double-track self-ground.

Step 820 may further include a step of picking up the horizontal magnetic field that is generated in a return path that is formed by the plurality of wires that are uniformly connected to the first transmission part and the second transmission part in parallel.

FIG. 9 is a diagram for describing a simulation process of a double-track self-grounded wireless charging model for the charging of an electric vehicle during driving according to an embodiment of the present disclosure.

FIG. 9 illustrates a reception part 910 and transmission part 920 of the double-track self-grounded wireless charging model for the charging of an electric vehicle during driving.

The three-dimensional model of the proposed system may be reduced into two-dimensional modeling because there is no change in a y direction. Thereafter, a proper geometric parameter is determined in order to obtain magnetic flux at an observation point. It is assumed that coupling between a plurality of wires of a transmission part may be neglected and the length of the wire is sufficient. The width W of the system and a height h between the transmission part 920 and the reception part 910 are determined by the road width and ground clearance of an electric vehicle. A distance d between the wires is a unique geometric parameter that is left.

An optimized system is simulated according to an FEM program. An operating frequency is 85 kHz, and a total of 1 A is uniformly distributed to the wires. In the FEM simulations, a magnetic flux value is similar to the results of numerical values and uniformly distributed in the y direction. However, modified modeling is required because FOM is too higher than expected FOM.

FIGS. 10A-10B are graphs illustrating the results of simulations of the double-track self-grounded wireless charging model for the charging of an electric vehicle during driving according to an embodiment of the present disclosure.

If n straight-line transmission lines are listed at arbitrary distances, a magnetic flux density B at a viewpoint that is distant by the height h is the sum of magnetic flux densities calculated by Ampere's law. In order to compare flatnesses of the magnetic flux densities, FOM that means a variation range is set as a reference value.

$$FOM = ( {B}_{max} - {B}_{min} ) / ( {B}_{max} + {B}_{min} )$$

FIG. 10A shows a model in which straight-line transmission lines are uniformly disposed. FIG. 10B shows a magnetic flux density of an optimized double-track transmission part. FOM of the optimized double-track transmission part is 9%, and shows a uniform magnetic field distribution in the lateral direction compared to an equivalent model having FOM of more than 13%.

The aforementioned apparatus may be implemented as a hardware component, a software component, and/or a combination of a hardware component and a software component. For example, the apparatus and component described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other apparatus capable of executing or responding to an instruction. The processing apparatus may perform an operating system (OS) and one or more software applications that are executed on the OS. Furthermore, the processing apparatus may access, store, manipulate, process, and generate data in response to the execution of software. For convenience of understanding, one processing apparatus has been illustrated as being used, but a person having ordinary knowledge in the art may understand that the processing apparatus may include a plurality of processing elements and/or a plurality of types of processing elements. For example, the processing apparatus may include a plurality of processors or one processor and one controller. Furthermore, another processing configuration, such as a parallel processor, is also possible.

Software may include a computer program, a code, an instruction or a combination of one or more of them, and may configure a processing apparatus so that the processing apparatus operates as desired or may instruct the processing apparatuses independently or collectively. The software and/or the data may be embodied in any type of machine, a component, a physical apparatus, virtual equipment, or a computer storage medium or apparatus in order to be interpreted by the processing apparatus or to provide an instruction or data to the processing apparatus. The software may be distributed to computer systems that are connected over a network, and may be stored or executed in a distributed manner. The software and the data may be stored in one or more computer-readable recording media.

The method according to an embodiment may be implemented in the form of a program instruction executable by various computer means and recorded on a computer-readable recording medium. The computer-readable recording medium may include a program instruction, a data file, and a data structure alone or in combination. The program instruction recorded on the medium may be specially designed and constructed for an embodiment, or may be known and available to those skilled in the computer software field. Examples of the computer-readable recording medium include magnetic media such as a hard disk, a floppy disk, and a magnetic tape, optical media such as CD-ROM and a DVD, magneto-optical media such as a floptical disk, and hardware devices specially configured to store and execute a program instruction, such as ROM, RAM, and a flash memory. Examples of the program instruction include not only machine language code produced by a compiler, but a high-level language code which may be executed by a computer using an interpreter, etc.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as a system, a structure, a device, and a circuit, are coupled or combined in a form different from that of the described method or replaced or substituted with other components or equivalents thereof.

Accordingly, other implementations, other embodiments, and the equivalents of the claims fall within the scope of the claims.

1. A double-track self-grounded wireless charging system comprising:
a transmission part comprising a plurality of wires that are uniformly connected to a road in parallel in order to generate a horizontal magnetic field for a charging of an electric vehicle during driving and not having a coil; and
a reception part comprising a coil for vertically receiving the horizontal magnetic field generated by the transmission part and mounted on the electric vehicle.

2. The double-track self-grounded wireless charging system of claim 1, wherein the transmission part has the plurality of wires that are uniformly connected to the road in parallel disposed therein, generates the horizontal magnetic field having a uniform magnetic flux density in a direction in which a current flows by the plurality of wires, and increases a driving range thereof without alignment sensitivity.

3. The double-track self-grounded wireless charging system of claim 2, wherein the transmission part provides a misalignment tolerance in a lateral direction by generating the horizontal magnetic field having the uniform magnetic flux density in the direction in which the current flows by the plurality of wires.

4. The double-track self-grounded wireless charging system of claim 1, wherein the transmission part applies a cascade wire in order to reduce equivalent serial resistance (ESR).

5. A double-track self-grounded wireless charging system comprising:
a first transmission part and a second transmission part each comprising a plurality of wires that are uniformly connected to a road in parallel in order to generate a horizontal magnetic field for a charging of an electric vehicle during driving and not having a coil, wherein directions of currents that flow into the first transmission part and the second transmission part are opposite to each other;
a reception part comprising a coil for vertically receiving the horizontal magnetic fields generated by the first transmission part and the second transmission part and mounted on the electric vehicle; and
a double-track self-ground configured to prevent a closed loop from being formed between the first transmission part and the second transmission part.

6. The double-track self-grounded wireless charging system of claim 5, wherein in the double-track self-ground, in order to reduce electromagnetic interference (EMI), a plurality of straight-line wires of the first transmission part is connected from a +pole of a power source to a plurality of straight-line wires of the second transmission part, and the plurality of straight-line wires of the second transmission part is connected to a −pole of the power source again so that the forming of the closed loop is prevented.

7. The double-track self-grounded wireless charging system of claim 6, wherein the reception part picks up a horizontal magnetic field that is generated from a return path that is formed due to the plurality of wires of the first transmission part and the second transmission part, which are uniformly connected in parallel.

8. The double-track self-grounded wireless charging system of claim 5, wherein:
each of the first transmission part and the second transmission part has the plurality of wires that are uniformly connected to the road in parallel disposed therein, generates the horizontal magnetic field having a uniform magnetic flux density in a direction in which a current flows by the plurality of wires, increases a driving range thereof without alignment sensitivity, and
the directions of the horizontal magnetic fields generated by the first transmission part and the second transmission part, respectively, are opposite to each other.

9. The double-track self-grounded wireless charging system of claim 8, wherein each of the first transmission part and the second transmission part provides a misalignment tolerance in a lateral direction by generating the horizontal magnetic field having the uniform magnetic flux density in the direction in which the current flows by the plurality of wires.

10. The double-track self-grounded wireless charging system of claim 5, wherein each of the first transmission part and the second transmission part applies a cascade wire in order to reduce equivalent serial resistance (ESR).

11. A double-track self-grounded wireless charging method comprising:
generating a horizontal magnetic field for a charging of an electric vehicle during driving through a transmission part comprising a plurality of wires that are uniformly connected to a road in parallel and not having a coil, wherein the transmission part comprises a first transmission part and a second transmission part and directions of currents flowing into the first transmission part and the second transmission part are opposite to each other; and
vertically receiving the horizontal magnetic field generated by the transmission part through a reception part comprising a coil and mounted on the electric vehicle.

12. The double-track self-grounded wireless charging method of claim 11, wherein in vertically receiving the horizontal magnetic field generated by the transmission part through a reception part comprising a coil and mounted on the electric vehicle, in order to reduce electromagnetic interference (EMI), a plurality of straight-line wires of the first transmission part is connected from a +pole of a power source to a plurality of straight-line wires of the second transmission part, and the plurality of straight-line wires of the second transmission part is connected to a −pole of the power source again so that the forming of the closed loop is prevented.

13. The double-track self-grounded wireless charging method of claim 12, wherein vertically receiving the horizontal magnetic field generated by the transmission part through a reception part comprising a coil and mounted on the electric vehicle further comprising picking up a horizontal magnetic field that is generated from a return path that is formed due to the plurality of wires of the first transmission part and the second transmission part, which are uniformly connected in parallel.

14. The double-track self-grounded wireless charging method of claim 11, wherein in generating a horizontal magnetic field for a charging of an electric vehicle during driving through a transmission part comprising a plurality of wires that are uniformly connected to a road in parallel and not having a coil,
each of the first transmission part and the second transmission part has the plurality of wires that are uniformly connected to the road in parallel disposed therein, generates the horizontal magnetic field having a uniform magnetic flux density in the direction in which the current flows by the plurality of wires, and increases a driving range thereof without alignment sensitivity, and
the directions of the horizontal magnetic fields generated by the first transmission part and the second transmission part, respectively, are opposite to each other.

15. The double-track self-grounded wireless charging method of claim 11, wherein generating a horizontal magnetic field for a charging of an electric vehicle during driving through a transmission part comprising a plurality of wires that are uniformly connected to a road in parallel and not having a coil comprises providing a misalignment tolerance in a lateral direction by generating the horizontal magnetic field having the uniform magnetic flux density in the direction in which the current flows by the plurality of wires.
